(19) United States
(12) Patent Application Publication
(10) Pub. No.: US 2026/0237032 A1
(43) Pub. Date: Aug. 13, 2026

(54) ROW AND COLUMN NOISE REDUCTION IN THERMAL IMAGES

(71) Applicant: Teledyne FLIR Commercial Systems, Inc., Goleta, CA (US)

(72) Inventor: Brenna Hensley, Goleta, CA (US)

(21) Appl. No.: 19/633,461

(22) Filed: Mar. 30, 2026

Related U.S. Application Data
(63) Continuation of application No. PCT/US2024/050342, filed on Oct. 8, 2024.
(60) Provisional application No. 63/588,990, filed on Oct. 9, 2023.

(51) Int. Cl. G06T 5/70

(52) U.S. Cl. CPC G06T 5/70; G06T 2207/10048; G06T 2207/20024

(57) ABSTRACT

Methods and systems are provided to reduce noise in infrared images. In one example, a method includes receiving an image frame comprising a plurality of pixels arranged in a plurality of rows and columns. The pixels include thermal image data associated with a scene and noise introduced by an infrared imaging device. The image frame may be processed to determine a plurality of column correction terms, each associated with a corresponding one of the columns and determined based on relative relationships between the pixels of the corresponding column and the pixels of a neighborhood of columns. The column correction terms may be modified to reduce residual noise and/or artefacts in the processed image frame.

### CROSS REFERENCE TO RELATED APPLICATIONS

This application is a continuation of International Patent Application No. PCT/US2024/050342 filed Oct. 8, 2024 and entitled “ROW AND COLUMN NOISE REDUCTION IN THERMAL IMAGES,” which claims priority to and the benefit of U.S. Provisional Patent Application No. 63/588,990 filed Oct. 9, 2023 and entitled “ROW AND COLUMN NOISE REDUCTION IN THERMAL IMAGES,” all of which are herein incorporated by reference in their entirety.

### TECHNICAL FIELD

One or more embodiments relate generally to thermal imaging and more particularly, for example, to techniques to reduce noise in thermal images.

### BACKGROUND

Infrared imaging devices (e.g., thermal imagers) often suffer from various types of noise, such as high spatial frequency fixed pattern noise (FPN). Some FPN may be correlated to rows and/or columns of infrared sensors. For example, FPN noise that appears as column noise may be caused by variations in column amplifiers and include a 1/f component. Such column noise can inhibit the ability to distinguish between desired vertical features of a scene and vertical FPN. Other FPN may be spatially uncorrelated, such as noise caused by pixel-to-pixel signal drift which may also include a 1/f component.

One conventional approach to removing FPN relies on an internal or external shutter that is selectively placed in front of infrared sensors of an infrared imaging device to provide a substantially uniform scene. The infrared sensors may be calibrated based on images captured of the substantially uniform scene while the shutter is positioned in front of the infrared sensors. Unfortunately, such a shutter may be prone to mechanical failure and potential non-uniformities (e.g., due to changes in temperature or other factors) which render it difficult to implement. Moreover, in applications where infrared imaging devices with small form factors may be desired, a shutter can increase the size and cost of such devices.

### BRIEF DESCRIPTION OF THE DRAWINGS

FIG. 1 shows a block diagram of a system for infrared image processing in accordance with an embodiment of the disclosure.

FIGS. 2A-C are flowcharts illustrating methods for noise filtering an infrared image in accordance with embodiments of the disclosure.

FIGS. 3A-C are graphs illustrating infrared image data and the processing of an infrared image in accordance with embodiments of the disclosure.

FIG. 4 shows a portion of a row of sensor data for discussing processing techniques in accordance with embodiments of the disclosure.

FIGS. 5A-C show an exemplary implementation of column and row noise filtering for an infrared image in accordance with embodiments of the disclosure.

FIG. 6A shows an infrared image of a scene including small vertical structure in accordance with an embodiment of the disclosure.

FIG. 6B shows a corrected version of the infrared image of FIG. 6A in accordance with an embodiment of the disclosure.

FIG. 7A shows an infrared image of a scene including a large vertical structure in accordance with an embodiment of the disclosure.

FIG. 7B shows a corrected version of the infrared image of FIG. 7A in accordance with an embodiment of the disclosure.

FIG. 8 is a flowchart illustrating another method for noise filtering an infrared image in accordance with an embodiment of the disclosure.

FIG. 9A shows a histogram prepared for the infrared image of FIG. 6A in accordance with an embodiment of the disclosure.

FIG. 9B shows a histogram prepared for the infrared image of FIG. 7A in accordance with an embodiment of the disclosure.

FIG. 10A illustrates an example image of low frequency artefacts in an infrared image in accordance with an embodiment of the disclosure.

FIG. 10B illustrates an example image of residual column noise from SCNR processing in accordance with an embodiment of the disclosure.

FIG. 11A illustrates an example image after SCNR noise reduction in accordance with an embodiment of the disclosure.

FIG. 11B illustrates an example image after low frequency noise reduction in accordance with an embodiment of the disclosure.

FIG. 11C illustrates an example image after mid frequency noise reduction in accordance with an embodiment of the disclosure.

FIG. 12 illustrates an example process for spatial column noise reduction and/or spatial row noise reduction that addresses multiscale and/or low frequency noise reduction in accordance an embodiment of the disclosure.

FIG. 13 illustrates example test results comparing temporal noise reduction, SCNR, and modified SCNR including low frequency and mid frequency adjustments in accordance with an embodiment of the disclosure.

Embodiments and their advantages are best understood by referring to the detailed description that follows. It should be appreciated that like reference numerals are used to identify like elements illustrated in one or more of the figures.

### DETAILED DESCRIPTION

In accordance with embodiments of the present disclosure, various image processing techniques are described which may be applied, for example, to infrared images (e.g., thermal images) to reduce noise within the infrared images (e.g., improve image detail and/or image quality) and/or provide non-uniformity correction.

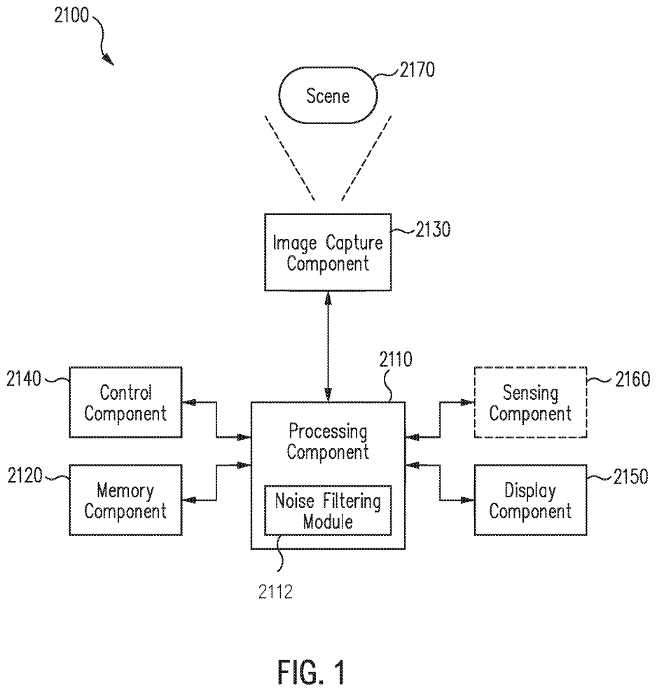

Referring to FIGS. 1-9B, various embodiments will be described with regard to a system 2100. However, the described techniques may be performed by other processing devices configured to operate on image frames captured by infrared sensors. A significant portion of the image noise may be defined as row and column noise, which may be characterized by non-linearities in a Read Out Integrated Circuit (ROIC). This type of noise, if not eliminated, may manifest as vertical and horizontal stripes in the final image and human observers are particularly sensitive to these types of image artifacts. Other systems relying on imagery from infrared sensors, such as, for example, automatic target trackers may also suffer from performance degradation, if row and column noise is present. In some embodiments, the techniques described herein may be used to reduce fixed pattern row and/or column noise in an infrared image.

Because of non-linear behavior of infrared detectors and ROIC assemblies, even when a shutter operation or external black body calibration is performed, there may be residual row and column noise (e.g., the scene being imaged may not have the exact same temperature as the shutter). The amount of row and column noise may increase over time, after offset calibration, increasing asymptotically to some maximum value. In one aspect, this may be referred to as 1/f type noise.

In any given frame, the row and column noise may be viewed as high frequency spatial noise. Conventionally, this type of noise may be reduced using filters in the spatial domain (e.g., local linear or non-linear low pass filters) or the frequency domain (e.g., low pass filters in Fourier or Wavelet space). However, these filters may have negative side effects, such as blurring of the image and potential loss of faint details.

It should be appreciated by those skilled in the art that any reference to a column or a row may include a partial column or a partial row and that the terms “row” and “column” are interchangeable and not limiting. Thus, without departing from the scope of this disclosure, the term “row” may be used to describe a row or a column, and likewise, the term “column” may be used to describe a row or a column, depending upon the application. It should further be appreciated that an image may be processed to reduce row noise, reduce column noise, and/or reduce both row noise and column noise.

FIG. 1 shows a block diagram of system 2100 (e.g., an infrared camera) for infrared image capturing and processing in accordance with an embodiment. In some embodiments, system 2100 may be implemented by infrared imaging module 100, host device 102, infrared sensor assembly 128, and/or various other components. Accordingly, although various techniques are described with regard to system 2100, such techniques may be similarly applied to other systems and devices.

The system 2100 comprises, in one implementation, a processing component 2110, a memory component 2120, an image capture component 2130, a control component 2140, and a display component 2150. Optionally, the system 2100 may include a sensing component 2160.

The system 2100 may represent an infrared imaging device, such as an infrared camera, to capture and process images, such as video images of a scene 2170. The system 2100 may represent any type of infrared camera adapted to detect infrared radiation and provide representative data and information (e.g., infrared image data of a scene). For example, the system 2100 may represent an infrared camera that is directed to the near, middle, and/or far infrared spectrums. In another example, the infrared image data may comprise non-uniform data (e.g., real image data that is not from a shutter or black body) of the scene 2170, for processing, as set forth herein. The system 2100 may comprise a portable device and may be incorporated, e.g., into a vehicle (e.g., an automobile or other type of land-based vehicle, an aircraft, or a spacecraft) or a non-mobile installation requiring infrared images to be stored and/or displayed.

In various embodiments, the processing component 2110 comprises a processor, such as one or more of a microprocessor, a single-core processor, a multi-core processor, a microcontroller, a logic device (e.g., a programmable logic device (PLD) configured to perform processing functions), a digital signal processing (DSP) device, etc. The processing component 2110 may be adapted to interface and communicate with components 2120, 2130, 2140, and 2150 to perform method and processing steps and/or operations, as described herein. The processing component 2110 may include a noise filtering module 2112 adapted to implement a noise reduction and/or removal algorithm (e.g., a noise filtering algorithm, such as any of those discussed herein). In one aspect, the processing component 2110 may be adapted to perform various other image processing algorithms including scaling the infrared image data, either as part of or separate from the noise filtering algorithm.

It should be appreciated that noise filtering module 2112 may be integrated in software and/or hardware as part of the processing component 2110, with code (e.g., software or configuration data) for the noise filtering module 2112 stored, e.g., in the memory component 2120. Embodiments of the noise filtering algorithm, as disclosed herein, may be stored by a separate computer-readable medium (e.g., a memory, such as a hard drive, a compact disk, a digital video disk, or a flash memory) to be executed by a computer (e.g., a logic or processor-based system) to perform various methods and operations disclosed herein. In one aspect, the computer-readable medium may be portable and/or located separate from the system 2100, with the stored noise filtering algorithm provided to the system 2100 by coupling the computer-readable medium to the system 2100 and/or by the system 2100 downloading (e.g., via a wired link and/or a wireless link) the noise filtering algorithm from the computer-readable medium.

The memory component 2120 comprises, in one embodiment, one or more memory devices adapted to store data and information, including infrared data and information. The memory device 2120 may comprise one or more various types of memory devices including volatile and non-volatile memory devices, such as RAM (Random Access Memory), ROM (Read-Only Memory), EEPROM (Electrically-Erasable Read-Only Memory), flash memory, etc. The processing component 2110 may be adapted to execute software stored in the memory component 2120 so as to perform method and process steps and/or operations described herein.

The image capture component 2130 comprises, in one embodiment, one or more infrared sensors (e.g., any type of multi-pixel infrared detector, such as a focal plane array) for capturing infrared image data (e.g., still image data and/or video data) representative of an image, such as scene 2170. In one implementation, the infrared sensors of the image capture component 2130 provide for representing (e.g., converting) the captured image data as digital data (e.g., via an analog-to-digital converter included as part of the infrared sensor or separate from the infrared sensor as part of the system 2100). In one aspect, the infrared image data (e.g., infrared video data) may comprise non-uniform data (e.g., real image data) of an image, such as scene 2170. The processing component 2110 may be adapted to process the infrared image data (e.g., to provide processed image data), store the infrared image data in the memory component 2120, and/or retrieve stored infrared image data from the memory component 2120. For example, the processing component 2110 may be adapted to process infrared image data stored in the memory component 2120 to provide processed image data and information (e.g., captured and/or processed infrared image data).

The control component 2140 comprises, in one embodiment, a user input and/or interface device, such as a rotatable knob (e.g., potentiometer), push buttons, slide bar, keyboard, etc., that is adapted to generate a user input control signal. The processing component 2110 may be adapted to sense control input signals from a user via the control component 2140 and respond to any sensed control input signals received therefrom. The processing component 2110 may be adapted to interpret such a control input signal as a value, as generally understood by one skilled in the art.

In one embodiment, the control component 2140 may comprise a control unit (e.g., a wired or wireless handheld control unit) having push buttons adapted to interface with a user and receive user input control values. In one implementation, the push buttons of the control unit may be used to control various functions of the system 2100, such as autofocus, menu enable and selection, field of view, brightness, contrast, noise filtering, high pass filtering, low pass filtering, and/or various other features as understood by one skilled in the art. In another implementation, one or more of the push buttons may be used to provide input values (e.g., one or more noise filter values, adjustment parameters, characteristics, etc.) for a noise filter algorithm. For example, one or more push buttons may be used to adjust noise filtering characteristics of infrared images captured and/or processed by the system 2100.

The display component 2150 comprises, in one embodiment, an image display device (e.g., a liquid crystal display (LCD)) or various other types of generally known video displays or monitors. The processing component 2110 may be adapted to display image data and information on the display component 2150. The processing component 2110 may be adapted to retrieve image data and information from the memory component 2120 and display any retrieved image data and information on the display component 2150. The display component 2150 may comprise display electronics, which may be utilized by the processing component 2110 to display image data and information (e.g., infrared images). The display component 2150 may be adapted to receive image data and information directly from the image capture component 2130 via the processing component 2110, or the image data and information may be transferred from the memory component 2120 via the processing component 2110.

The optional sensing component 2160 comprises, in one embodiment, one or more sensors of various types, depending on the application or implementation requirements, as would be understood by one skilled in the art. The sensors of the optional sensing component 2160 provide data and/or information to at least the processing component 2110. In one aspect, the processing component 2110 may be adapted to communicate with the sensing component 2160 (e.g., by receiving sensor information from the sensing component 2160) and with the image capture component 2130 (e.g., by receiving data and information from the image capture component 2130 and providing and/or receiving command, control, and/or other information to and/or from one or more other components of the system 2100).

In various implementations, the sensing component 2160 may provide information regarding environmental conditions, such as outside temperature, lighting conditions (e.g., day, night, dusk, and/or dawn), humidity level, specific weather conditions (e.g., sun, rain, and/or snow), distance (e.g., laser rangefinder), and/or whether a tunnel or other type of enclosure has been entered or exited. The sensing component 2160 may represent conventional sensors as generally known by one skilled in the art for monitoring various conditions (e.g., environmental conditions) that may have an effect (e.g., on the image appearance) on the data provided by the image capture component 2130.

In some implementations, the optional sensing component 2160 (e.g., one or more of sensors) may comprise devices that relay information to the processing component 2110 via wired and/or wireless communication. For example, the optional sensing component 2160 may be adapted to receive information from a satellite, through a local broadcast (e.g., radio frequency (RF)) transmission, through a mobile or cellular network and/or through information beacons in an infrastructure (e.g., a transportation or highway information beacon infrastructure), or various other wired and/or wireless techniques.

In various embodiments, components of the system 2100 may be combined and/or implemented or not, as desired or depending on the application or requirements, with the system 2100 representing various functional blocks of a related system. In one example, the processing component 2110 may be combined with the memory component 2120, the image capture component 2130, the display component 2150, and/or the optional sensing component 2160. In another example, the processing component 2110 may be combined with the image capture component 2130 with only certain functions of the processing component 2110 performed by circuitry (e.g., a processor, a microprocessor, a logic device, a microcontroller, etc.) within the image capture component 2130. Furthermore, various components of the system 2100 may be remote from each other (e.g., image capture component 2130 may comprise a remote sensor with processing component 2110, etc. representing a computer that may or may not be in communication with the image capture component 2130).

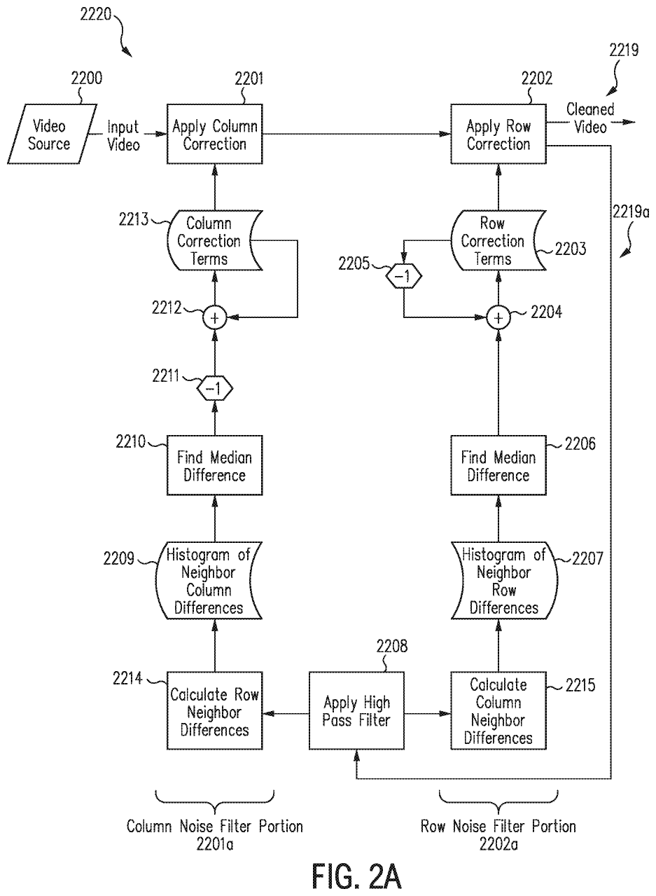

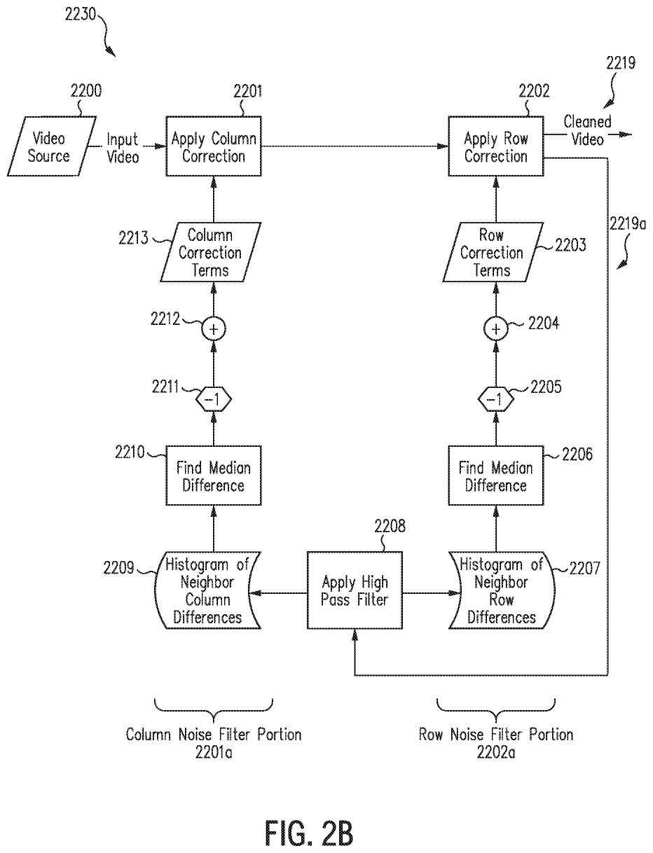

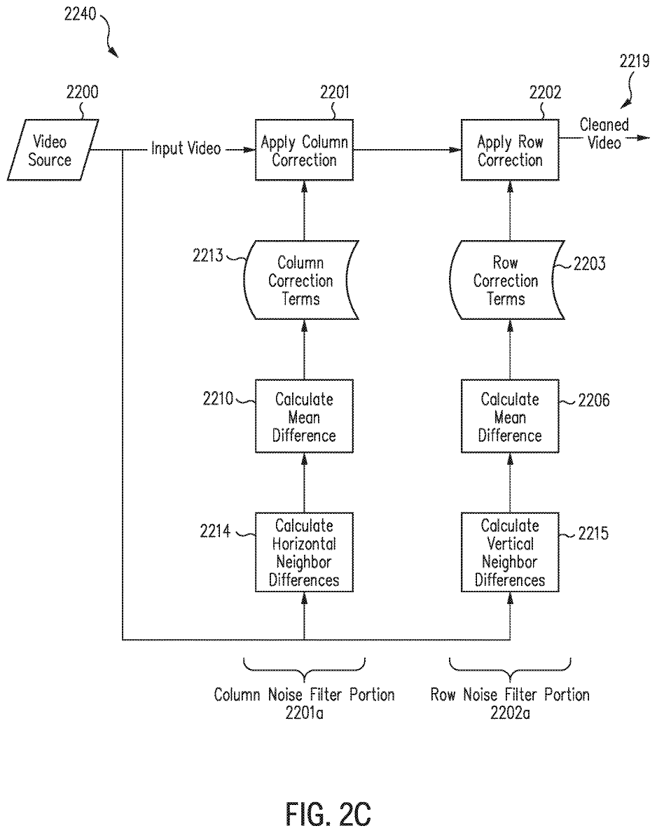

In accordance with an embodiment of the disclosure, FIG. 2A shows a method 2220 for noise filtering an infrared image. In one implementation, this method 2220 relates to the reduction and/or removal of temporal, 1/f, and/or fixed spatial noise in infrared imaging devices, such as infrared imaging system 2100 of FIG. 1. The method 2220 is adapted to utilize the row and column based noise components of infrared image data in a noise filtering algorithm. In one aspect, the row and column based noise components may dominate the noise in imagery of infrared sensors (e.g., approximately ⅔ of the total noise may be spatial in a typical micro-bolometer based system).

In one embodiment, the method 2220 of FIG. 2A comprises a high level block diagram of row and column noise filtering algorithms. In one aspect, the row and column noise filter algorithms may be optimized to use minimal hardware resources.

Referring to FIG. 2A, the process flow of the method 2220 implements a recursive mode of operation, wherein the previous correction terms are applied before calculating row and column noise, which may allow for correction of lower spatial frequencies. In one aspect, the recursive approach is useful when row and column noise is spatially correlated. This is sometimes referred to as banding and, in the column noise case, may manifest as several neighboring columns being affected by a similar offset error. When several neighbors used in difference calculations are subject to similar error, the mean difference used to calculate the error may be skewed, and the error may only be partially corrected. By applying partial correction prior to calculating the error in the current frame, correction of the error may be recursively reduced until the error is minimized or eliminated. In the recursive case, if the HPF is not applied (block 2208), then natural gradients as part of the image may, after several iterations, be distorted when merged into the noise model. In one aspect, a natural horizontal gradient may appear as low spatially correlated column noise (e.g., severe banding). In another aspect, the HPF may prevent very low frequency scene information to interfere with the noise estimate and, therefore, limits the negative effects of recursive filtering.

Referring to method 2220 of FIG. 2A, infrared image data (e.g., a raw video source, such as from the image capture component 2130 of FIG. 1) is received as input video data (block 2200). Next, column correction terms are applied to the input video data (block 2201), and row correction terms are applied to the input video data (block 2202). Next, video data (e.g., “cleaned” video data) is provided as output video data (2219) after column and row corrections are applied to the input video data. In one aspect, the term “cleaned” may refer to removing or reducing noise (blocks 2201, 2202) from the input video data via, e.g., one or more embodiments of the noise filter algorithm.

Referring to the processing portion (e.g., recursive processing) of FIG. 2A, a HPF is applied (block 2208) to the output video data 2219 via data signal path 2219a. In one implementation, the high pass filtered data is separately provided to a column noise filter portion 2201a and a row noise filter portion 2202a.

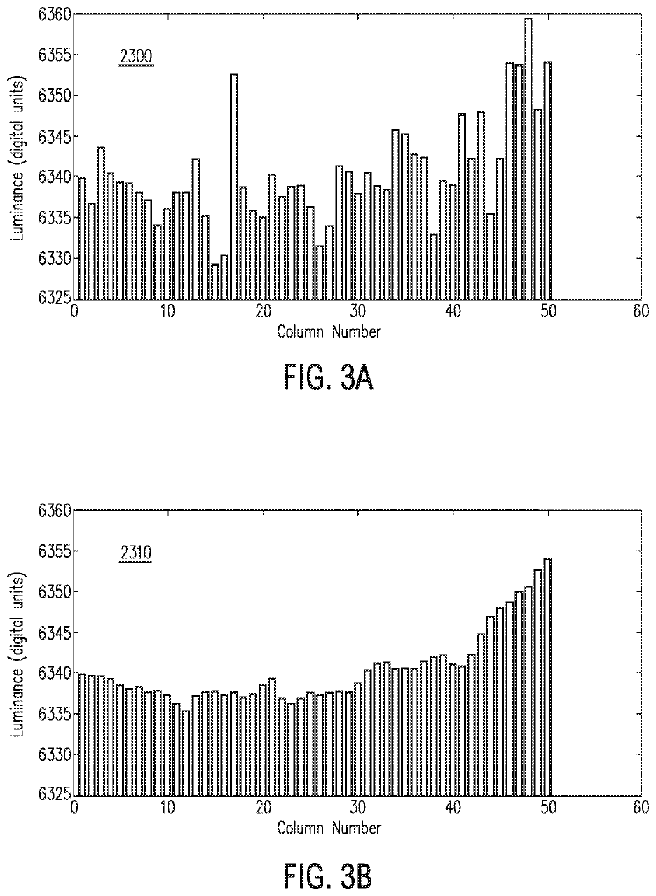

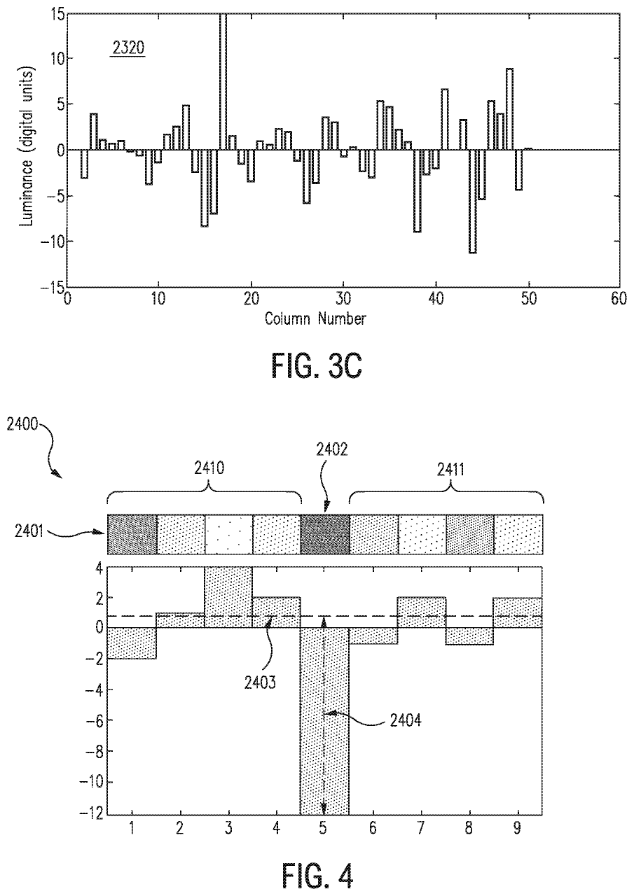

Referring to the column noise filter portion 2201a, the method 2220 may be adapted to process the input video data 2200 and/or output video data 2219 as follows:
1. Apply previous column noise correction terms to a current frame as calculated in a previous frame (block 2201).
2. High pass filter the row of the current frame by subtracting the result of a low pass filter (LPF) operation (block 2208), for example, as discussed in reference to FIGS. 3A-3C.
3. For each pixel, calculate a difference between a center pixel and one or more (e.g., eight) nearest neighbors (block 2214). In one implementation, the nearest neighbors comprise one or more nearest horizontal neighbors. The nearest neighbors may include one or more vertical or other non-horizontal neighbors (e.g., not pure horizontal, i.e., on the same row), without departing from the scope of this disclosure.
4. If the calculated difference is below a predefined threshold, add the calculated difference to a histogram of differences for the specific column (block 2209).
5. At an end of the current frame, find a median difference by examining a cumulative histogram of differences (block 2210). In one aspect, for added robustness, only differences with some specified minimum number of occurrences may be used.
6. Delay the current correction terms for one frame (block 2211), i.e., they are applied to the next frame.
7. Add median difference (block 2212) to previous column correction terms to provide updated column correction terms (block 2213).
8. Apply updated column noise correction terms in the next frame (block 2201).

Referring to the row noise filter portion 2202a, the method 2220 may be adapted to process the input video data 2200 and/or output video data 2219 as follows:
1. Apply previous row noise correction terms to a current frame as calculated in a previous frame (block 2202).
2. High pass filter the column of the current frame by subtracting the result of a low pass filter (LPF) operation (block 2208), as discussed similarly above for column noise filter portion 2201a.
3. For each pixel, calculate a difference between a center pixel and one or more (e.g., eight) nearest neighbors (block 2215). In one implementation, the nearest neighbors comprise one or more nearest vertical neighbors. The nearest neighbors may include one or more horizontal or other non-vertical neighbors (e.g., not pure vertical, i.e., on the same column), without departing from the scope of this disclosure.
4. If the calculated difference is below a predefined threshold, add the calculated difference to a histogram of differences for the specific row (block 2207).
5. At an end of the current row (e.g., line), find a median difference by examining a cumulative histogram of differences (block 2206). In one aspect, for added robustness only differences with some specified minimum number of occurrences may be used.
6. Delay the current frame by a time period equivalent to the number of nearest vertical neighbors used, for example eight.
7. Add median difference (block 2204) to row correction terms (block 2203) from previous frame (block 2205).
8. Apply updated row noise correction terms in the current frame (block 2202). In one aspect, this may require a row buffer (e.g., as mentioned in 6).

In one aspect, for all pixels (or at least a large subset of them) in each column, an identical offset term (or set of terms) may be applied for each associated column. This may prevent the filter from blurring spatially local details.

Similarly, in one aspect, for all pixels (or at least a large subset of them) in each row respectively, an identical offset term (or set of terms) may be applied. This may inhibit the filter from blurring spatially local details.

In one example, an estimate of the column offset terms may be calculated using only a subset of the rows (e.g., the first 32 rows). In this case, only a 32 row delay is needed to apply the column correction terms in the current frame. This may improve filter performance in removing high temporal frequency column noise. Alternatively, the filter may be designed with minimum delay, and the correction terms are only applied once a reasonable estimate can be calculated (e.g., using data from the 32 rows). In this case, only rows 33 and beyond may be optimally filtered.

In one aspect, all samples may not be needed, and in such an instance, only every 2nd or 4th row, e.g., may be used for calculating the column noise. In another aspect, the same may apply when calculating row noise, and in such an instance, only data from every 4th column, e.g., may be used. It should be appreciated that various other iterations may be used by one skilled in the art without departing from the scope of this disclosure.

In one aspect, the filter may operate in recursive mode in which the filtered data is filtered instead of the raw data being filtered. In another aspect, the mean difference between a pixel in one row and pixels in neighboring rows may be approximated in an efficient way if a recursive (IIR) filter is used to calculate an estimated running mean. For example, instead of taking the mean of neighbor differences (e.g., eight neighbor differences), the difference between a pixel and the mean of the neighbors may be calculated.

In accordance with an embodiment of the disclosure, FIG. 2B shows an alternative method 2230 for noise filtering infrared image data. In reference to FIGS. 2A and 2B, one or more of the process steps and/or operations of method 2220 of FIG. 2A have changed order or have been altered or combined for the method 2230 of FIG. 2B. For example, the operation of calculating row and column neighbor differences (blocks 2214, 2215) may be removed or combined with other operations, such as generating histograms of row and column neighbor differences (blocks 2207, 2209). In another example, the delay operation (block 2205) may be performed after finding the median difference (block 2206). In various examples, it should be appreciated that similar process steps and/or operations have similar scope, as previously described in FIG. 2A, and therefore, the description will not be repeated.

In still other alternate approaches to methods 2220 and 2230, embodiments may exclude the histograms and rely on mean calculated differences instead of median calculated differences. In one aspect, this may be slightly less robust but may allow for a simpler implementation of the column and row noise filters. For example, the mean of neighboring rows and columns, respectively, may be approximated by a running mean implemented as an infinite impulse response (IIR) filter. In the row noise case, the HR filter implementation may reduce or even eliminate the need to buffer several rows of data for mean calculations.

In still other alternate approaches to methods 2220 and 2230, new noise estimates may be calculated in each frame of the video data and only applied in the next frame (e.g., after noise estimates). In one aspect, this alternate approach may provide less performance but may be easier to implement. In another aspect, this alternate approach may be referred to as a non-recursive method, as understood by those skilled in the art.

For example, in one embodiment, the method 2240 of FIG. 2C comprises a high level block diagram of row and column noise filtering algorithms. In one aspect, the row and column noise filter algorithms may be optimized to use minimal hardware resources. In reference to FIGS. 2A and 2B, similar process steps and/or operations may have similar scope, and therefore, the descriptions will not be repeated.

Referring to FIG. 2C, the process flow of the method 2240 implements a non-recursive mode of operation. As shown, the method 2240 applies column offset correction term 2201 and row offset correction term 2202 to the uncorrected input video data from video source 2200 to produce, e.g., a corrected or cleaned output video signal 2219. In column noise filter portion 2201a, column offset correction terms 2213 are calculated based on the mean difference 2210 between pixel values in a specific column and one or more pixels belonging to neighboring columns 2214. In row noise filter portion 2202a, row offset correction terms 2203 are calculated based on the mean difference 2206 between pixel values in a specific row and one or more pixels belonging to neighboring rows 2215. In one aspect, the order (e.g., rows first or columns first) in which row or column offset correction terms 2203, 2213 are applied to the input video data from video source 2200 may be considered arbitrary. In another aspect, the row and column correction terms may not be fully known until the end of the video frame, and therefore, if the input video data from the video source 2200 is not delayed, the row and column correction terms 2203, 2213 may not be applied to the input video data from which they were calculated.

In one aspect, the column and row noise filter algorithm may operate continuously on image data provided by an infrared imaging sensor (e.g., image capture component 2130 of FIG. 1). Unlike conventional methods that may require a uniform scene (e.g., as provided by a shutter or external calibrated black body) to estimate the spatial noise, the column and row noise filter algorithms, as set forth in one or more embodiments, may operate on real-time scene data. In one aspect, an assumption may be made that, for some small neighborhood around location [x, y], neighboring infrared sensor elements should provide similar values since they are imaging parts of the scene in close proximity. If the infrared sensor reading from a particular infrared sensor element differs from a neighbor, then this could be the result of spatial noise. However, in some instances, this may not be true for each and every sensor element in a particular row or column (e.g., due to local gradients that are a natural part of the scene), but on average, a row or column may have values that are close to the values of the neighboring rows and columns.

For one or more embodiments, by first taking out one or more low spatial frequencies (e.g., using a high pass filter (HPF)), the scene contribution may be minimized to leave differences that correlate highly with actual row and column spatial noise. In one aspect, by using an edge preserving filter, such as a Median filter or a Bilateral filter, one or more embodiments may minimize artifacts due to strong edges in the image.

In accordance with one or more embodiments of the disclosure, FIGS. 3A to 3C show a graphical implementation (e.g., digital counts versus data columns) of filtering an infrared image. FIG. 3A shows a graphical illustration (e.g., graph 2300) of typical values, as an example, from a row of sensor elements when imaging a scene. FIG. 3B shows a graphical illustration (e.g., graph 2310) of a result of a low pass filtering (LPF) of the image data values from FIG. 3A. FIG. 3C shows a graphical illustration (e.g., graph 2320) of subtracting the low pass filter (LPF) output in FIG. 3B from the original image data in FIG. 3A, which results in a high pass filter (HPF) profile with low and mid frequency components removed from the scene of the original image data in FIG. 3A. Thus, FIGS. 3A-3C illustrate a HPF technique, which may be used for one or more embodiments (e.g., as with methods 2220 and/or 2230).

In one aspect, a final estimate of column and/or row noise may be referred to as an average or median estimate of all of the measured differences. Because noise characteristics of an infrared sensor are often generally known, then one or more thresholds may be applied to the noise estimates. For example, if a difference of 60 digital counts is measured, but it is known that the noise typically is less than 10 digital counts, then this measurement may be ignored.

In accordance with one or more embodiments of the disclosure, FIG. 4 shows a graphical illustration 2400 (e.g., digital counts versus data columns) of a row of sensor data 2401 (e.g., a row of pixel data for a plurality of pixels in a row) with column 5 data 2402 and data for eight nearest neighbors (e.g., nearest pixel neighbors, 4 columns 2410 to the left of column 5 data 2402 and 4 columns 2411 to the right of column 5 data 2402). In one aspect, referring to FIG. 4, the row of sensor data 2401 is part of a row of sensor data for an image or scene captured by a multi-pixel infrared sensor or detector (e.g., image capture component 2130 of FIG. 1). In one aspect, column 5 data 2402 is a column of data to be corrected. For this row of sensor data 2401, the difference between column 5 data 2402 and a mean 2403 of its neighbor columns (2410, 2411) is indicated by an arrow 2404. Therefore, noise estimates may be obtained and accounted for based on neighboring data.

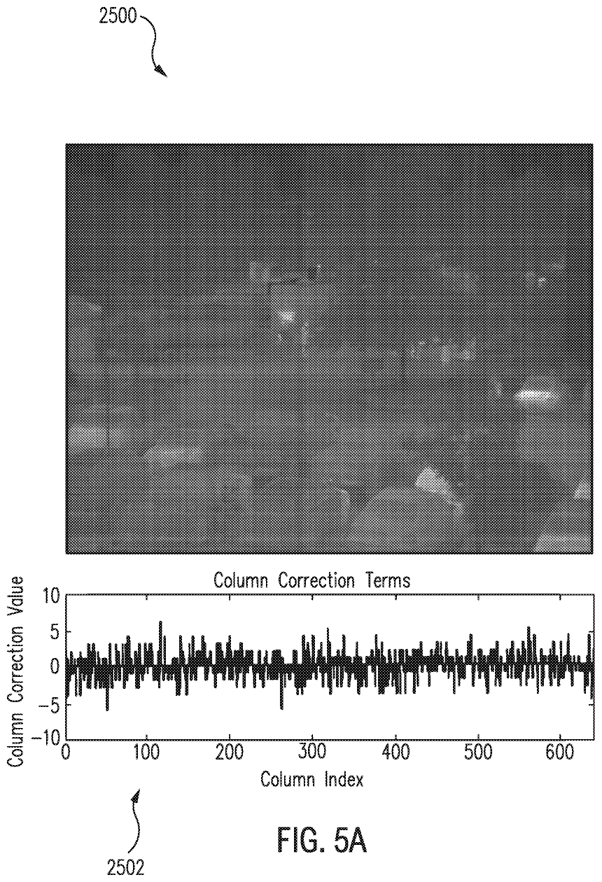

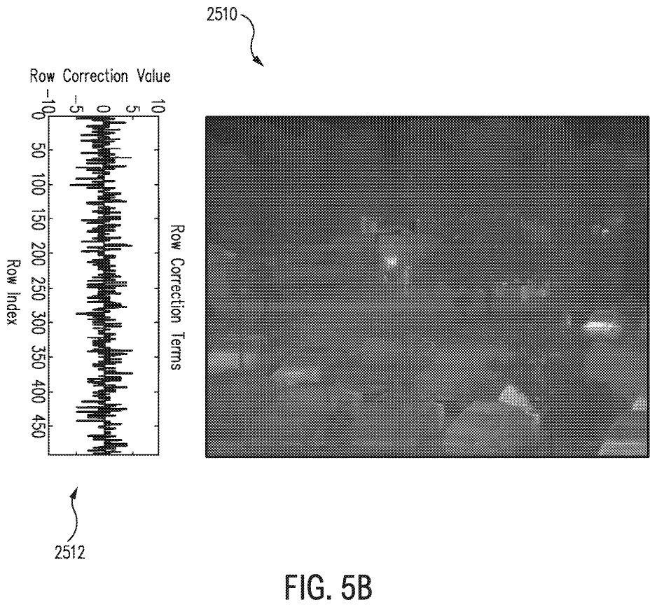

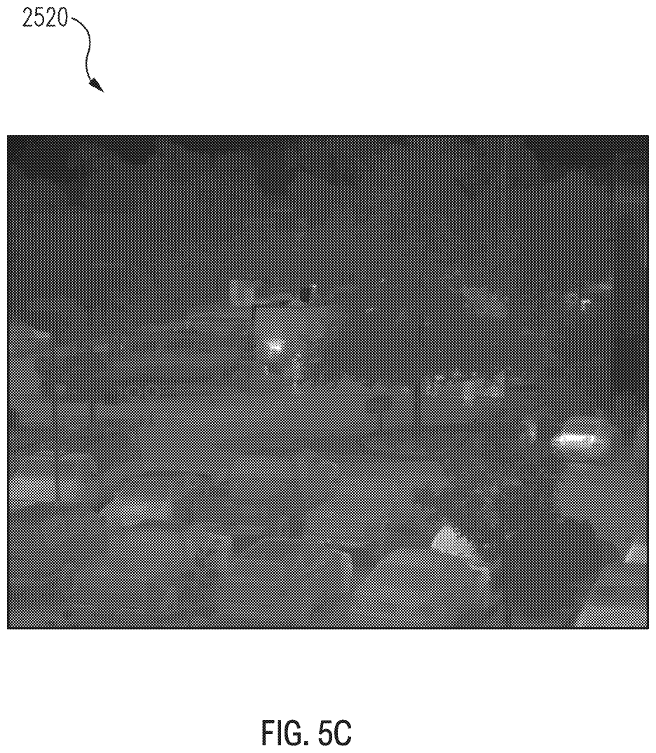

In accordance with one or more embodiments of the disclosure, FIGS. 5A to 5C show an exemplary implementation of column and row noise filtering an infrared image (e.g., an image frame from infrared video data). FIG. 5A shows an infrared image 2500 with column noise estimated from a scene with severe row and column noise present and a corresponding graph 2502 of column correction terms. FIG. 5B shows an infrared image 2510, with column noise removed and spatial row noise still present, with row correction terms estimated from the scene in FIG. 5A and a corresponding graph 2512 of row correction terms. FIG. 5C shows an infrared image 2520 of the scene in FIG. 5A as a cleaned infrared image with row and column noise removed (e.g., column and row correction terms of FIGS. 5A-5B applied).

In one embodiment, FIG. 5A shows an infrared video frame (i.e., infrared image 2500) with severe row and column noise. Column noise correction coefficients are calculated as described herein to produce, e.g., 639 correction terms, i.e., one correction term per column. The graph 2502 shows the column correction terms. These offset correction terms are subtracted from the infrared video frame 2500 of FIG. 5A to produce the infrared image 2510 in FIG. 5B. As shown in FIG. 5B, the row noise is still present. Row noise correction coefficients are calculated as described herein to produce, e.g., 639 row terms, i.e., one correction term per row. The graph 2512 shows the row offset correction terms, which are subtracted from the infrared image 2510 in FIG. 5B to produce the cleaned infrared image 2520 in FIG. 5C with significantly reduced or removed row and column noise.

In various embodiments, it should be understood that both row and column filtering is not required. For example, either column noise filtering 2201a or row noise filtering 2202a may be performed in methods 2220, 2230 or 2240.

It should be appreciated that any reference to a column or a row may include a partial column or a partial row and that the terms “row” and “column” are interchangeable and not limiting. For example, without departing from the scope of this disclosure, the term “row” may be used to describe a row or a column, and likewise, the term “column” may be used to describe a row or a column, depending upon the application.

In various aspects, column and row noise may be estimated by looking at a real scene (e.g., not a shutter or a black body), in accordance with embodiments of the noise filtering algorithms, as disclosed herein. The column and row noise may be estimated by measuring the median or mean difference between sensor readings from elements in a specific row (and/or column) and sensor readings from adjacent rows (and/or columns).

Optionally, a high pass filter may be applied to the image data prior to measuring the differences, which may reduce or at least minimize a risk of distorting gradients that are part of the scene and/or introducing artifacts. In one aspect, only sensor readings that differ by less than a configurable threshold may be used in the mean or median estimation. Optionally, a histogram may be used to effectively estimate the median. Optionally, only histogram bins exceeding a minimum count may be used when finding the median estimate from the histogram. Optionally, a recursive IR filter may be used to estimate the difference between a pixel and its neighbors, which may reduce or at least minimize the need to store image data for processing, e.g., the row noise portion (e.g., if image data is read out row wise from the sensor). In one implementation, the current mean column value C̅_{i,j} for column i at row j may be estimated using the following recursive filter algorithm.

$${\overline{C}}_{i , j} = ( 1 - α ) \cdot {\overline{C}}_{i - 1 , j} + α \cdot {C}_{i , j}$$

$$Δ {R}_{i} = \frac{1}{N} {\sum }_{j = 1}^{N} {C}_{i , j} - {\overline{C}}_{i - 1 , j}$$

In this equation α is the damping factor and may be set to for example 0.2 in which case the estimate for the running mean of a specific column i at row j will be a weighted sum of the estimated running mean for column i−1 at row j and the current pixel value at row j and column i. The estimated difference between values of row j and the values of neighboring rows can now be approximated by taking the difference of each value C_{i,j} and the running recursive mean of the neighbors above row i (C̅_{i-1,j}). Estimating the mean difference this way is not as accurate as taking the true mean difference since only rows above are used but it requires that only one row of running means are stored as compared to several rows of actual pixel values be stored.

In one embodiment, referring to FIG. 2A, the process flow of method 2220 may implement a recursive mode of operation, wherein the previous column and row correction terms are applied before calculating row and column noise, which allows for correction of lower spatial frequencies when the image is high pass filtered prior to estimating the noise.

Generally, during processing, a recursive filter re-uses at least a portion of the output data as input data. The feedback input of the recursive filter may be referred to as an infinite impulse response (IIR), which may be characterized, e.g., by exponentially growing output data, exponentially decaying output data, or sinusoidal output data. In some implementations, a recursive filter may not have an infinite impulse response. As such, e.g., some implementations of a moving average filter function as recursive filters but with a finite impulse response (FIR).

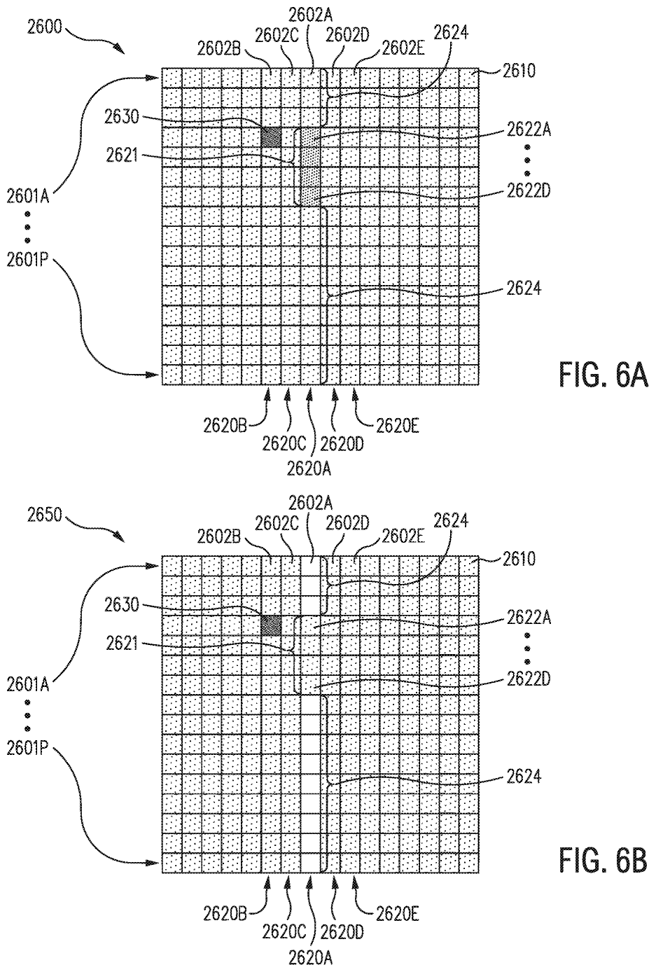

As further set forth in the description of FIGS. 6A to 9B, additional techniques are contemplated to determine row and/or column correction terms. For example, in some embodiments, such techniques may be used to provide correction terms without overcompensating for the presence of vertical and/or horizontal objects present in scene 2170. Such techniques may be used in any appropriate environment where such objects may be frequently captured including, for example, urban applications, rural applications, vehicle applications, and others. In some embodiments, such techniques may provide correction terms with reduced memory and/or reduced processing overhead in comparison with other approaches used to determine correction terms.

FIG. 6A shows an infrared image 2600 (e.g., infrared image data) of scene 2170 in accordance with an embodiment of the disclosure. Although infrared image 2600 is depicted as having 16 rows and 16 columns, other image sizes are contemplated for infrared image 2600 and the various other infrared images discussed herein. For example, in one embodiment, infrared image 2600 may have 640 columns and 512 rows.

In FIG. 6A, infrared image 2600 depicts scene 2170 as relatively uniform, with a majority of pixels 2610 of infrared image 2600 having the same or similar intensity (e.g., the same or similar numbers of digital counts). Also in this embodiment, scene 2170 includes an object 2621 which appears in pixels 2622A-D of a column 2620A of infrared image 2600. In this regard, pixels 2622A-D are depicted somewhat darker than other pixels 2610 of infrared image 2600. For purposes of discussion, it will be assumed that darker pixels are associated with higher numbers of digital counts, however lighter pixels may be associated with higher numbers of digital counts in other implementations if desired. As shown, the remaining pixels 2624 of column 2620A have a substantially uniform intensity with pixels 2610.

In some embodiments, object 2621 may be a vertical object such as a building, telephone pole, light pole, power line, cellular tower, tree, human being, and/or other object. If image capture component 2130 is disposed in a vehicle approaching object 2621, then object 2621 may appear relatively fixed in infrared image 2600 while the vehicle is still sufficiently far away from object 2621 (e.g., object 2621 may remain primarily represented by pixels 2622A-D and may not significantly shift position within infrared image 2600). If image capture component 2130 is disposed at a fixed location relative to object 2621, then object 2621 may also appear relatively fixed in infrared image 2600 (e.g., if object 2621 is fixed and/or is positioned sufficiently far away). Other dispositions of image capture component 2130 relative to object 2621 are also contemplated.

Infrared image 2600 also includes another pixel 2630 which may be attributable to, for example, temporal noise, fixed spatial noise, a faulty sensor/circuitry, actual scene information, and/or other sources. As shown in FIG. 6A, pixel 2630 is darker (e.g., has a higher number of digital counts) than all of pixels 2610 and 2622A-D.

Vertical objects such as object 2621 depicted by pixels 2622A-D are often problematic for some column correction techniques. In this regard, objects that remain disposed primarily in one or several columns may result in overcompensation when column correction terms are calculated without regard to the possible presence of small vertical objects appearing in scene 2170. For example, when pixels 2622A-D of column 2620A are compared with those of nearby columns 2620B-E, some column correction techniques may interpret pixels 2622A-D as column noise, rather than actual scene information. Indeed, the significantly darker appearance of pixels 2622A-D relative to pixels 2610 and the relatively small width of object 2621 disposed in column 2620A may skew the calculation of a column correction term to significantly correct the entire column 2620A, although only a small portion of column 2620A actually includes darker scene information. As a result, the column correction term determined for column 2620A may significantly lighten (e.g., brighten or reduce the number of digital counts) column 2620A to compensate for the assumed column noise.

For example, FIG. 6B shows a corrected version 2650 of infrared image 2600 of FIG. 6A. As shown in FIG. 6B, column 2620A has been significantly brightened. Pixels 2622A-D have been made significantly lighter to be approximately uniform with pixels 2610, and the actual scene information (e.g., the depiction of object 2621) contained in pixels 2622A-D has been mostly lost. In addition, remaining pixels 2624 of column 2620A have been significantly brightened such that they are no longer substantially uniform with pixels 2610. Indeed, the column correction term applied to column 2620A has actually introduced new non-uniformities in pixels 2624 relative to the rest of scene 2170.

Various techniques described herein may be used to determine column correction terms without overcompensating for the appearance of various vertical objects that may be present in scene 2170. For example, in one embodiment, when such techniques are applied to column 2620A of FIG. 6A, the presence of dark pixels 2622A-D may not cause any further changes to the column correction term for column 2620A (e.g., after correction is applied, column 2620A may appear as shown in FIG. 6A rather than as shown in FIG. 6B).

In accordance with various embodiments further described herein, corresponding column correction terms may be determined for each column of an infrared image without overcompensating for the presence of vertical objects present in scene 2170. In this regard, a first pixel of a selected column of an infrared image (e.g., the pixel of the column residing in a particular row) may be compared with a corresponding set of other pixels (e.g., also referred to as neighborhood pixels) that are within a neighborhood associated with the first pixel. In some embodiments, the neighborhood may correspond to pixels in the same row as the first pixel that are within a range of columns. For example, the neighborhood may be defined by an intersection of: the same row as the first pixel; and a predetermined range of columns.

The range of columns may be any desired number of columns on the left side, right side, or both left and right sides of the selected column. In this regard, if the range of columns corresponds to two columns on both sides of the selected column, then four comparisons may be made for the first pixel (e.g., two columns to the left of the selected column, and two columns to the right of the selected column). Although a range of two columns on both sides of the selected column is further described herein, other ranges are also contemplated (e.g., 5 columns, 8 columns, or any desired number of columns).

One or more counters (e.g., registers, memory locations, accumulators, and/or other implementations in processing component 2110, noise filtering module 2112, memory component 2120, and/or other components) are adjusted (e.g., incremented, decremented, or otherwise updated) based on the comparisons. In this regard, for each comparison where the pixel of the selected column has a lesser value than a compared pixel, a counter A may be adjusted. For each comparison where the pixel of the selected column has an equal (e.g., exactly equal or substantially equal) value as a compared pixel, a counter B may be adjusted. For each comparison where the pixel of the selected column has a greater value than a compared pixel, a counter C may be adjusted. Thus, if the range of columns corresponds to two columns on either side of the selected column as identified in the example above, then a total of four adjustments (e.g., counts) may be collectively held by counters A, B, and C.

After the first pixel of the selected column is compared with all pixels in its corresponding neighborhood, the process is repeated for all remaining pixels in the selected column (e.g., one pixel for each row of the infrared image), and counters A, B, and C continue to be adjusted in response to the comparisons performed for the remaining pixels. In this regard, in some embodiments, each pixel of the selected column may be compared with a different corresponding neighborhood of pixels (e.g., pixels residing: in the same row as the pixel of the selected column; and within a range of columns), and counters A, B, and C may be adjusted based on the results of such comparisons.

As a result, after all pixels of the selected column are compared, counters A, B, and C may identify the number of comparisons for which pixels of the selected column were found to be greater, equal, or less than neighborhood pixels. Thus, continuing the example above, if the infrared image has 16 rows, then a total of 64 counts may be distributed across counters A, B, and C for the selected column (e.g., 4 counts per row×16 rows=64 counts). It is contemplated that other numbers of counts may be used. For example, in a large array having 512 rows and using a range of 10 columns, 5120 counts (e.g., 512 rows×10 columns) may be used to determine each column correction term.

Based on the distribution of the counts in counters A, B, and C, the column correction term for the selected column may be selectively incremented, decremented, or remain the same based on one or more calculations performed using values of one or more of counters A, B, and/or C. For example, in some embodiments: the column correction term may be incremented if counter A−counter B−counter C>D; the column correction term may be decremented if counter C−counter A−counter B>D; and the column correction term may remain the same in all other cases. In such embodiments, D may be a value such as a constant value smaller than the total number of comparisons accumulated by counters A, B, and C per column. For example, in one embodiment, D may have a value equal to: (number of rows)/2.

The process may be repeated for all remaining columns of the infrared image in order to determine (e.g., calculate and/or update) a corresponding column correction term for each column of the infrared image. In addition, after column correction terms have been determined for one or more columns, the process may be repeated for one or more columns (e.g., to increment, decrement, or not change one or more column correction terms) after the column corrected terms are applied to the same infrared image and/or another infrared image (e.g., a subsequently captured infrared image).

As discussed, counters A, B, and C identify the number of compared pixels that are less than, equal to, or greater than pixels of the selected column. This contrasts with various other techniques used to determine column correction terms where the actual differences (e.g., calculated difference values) between compared pixels may be used.

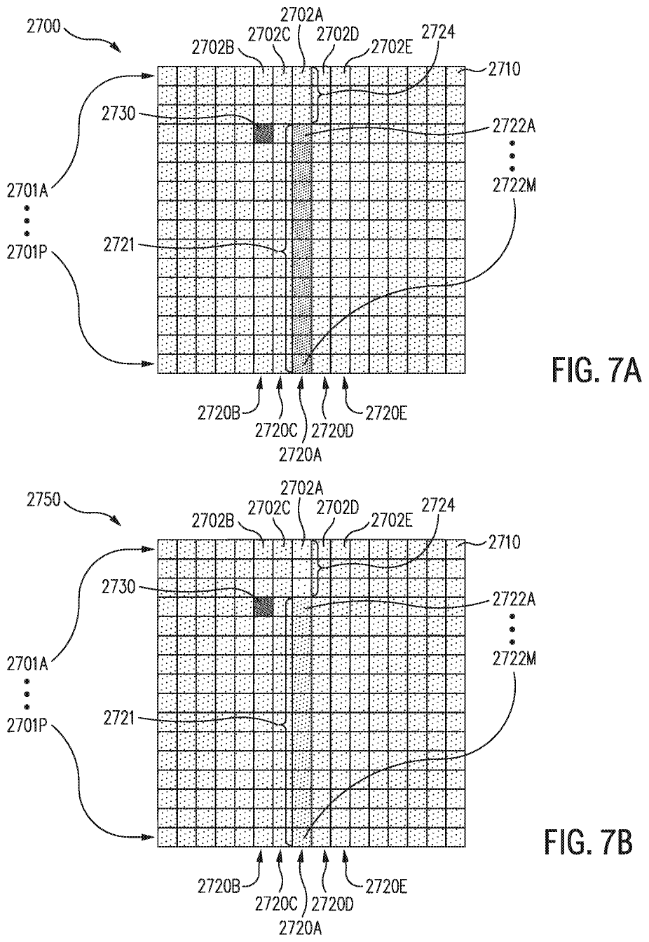

By determining column correction terms based on less than, equal to, or greater than relationships (e.g., rather than the actual numerical differences between the digital counts of different pixels), the column correction terms may be less skewed by the presence of small vertical objects appearing in infrared images. In this regard, by using this approach, small objects such as object 2621 with high numbers of digital counts may not inadvertently cause column correction terms to be calculated that would overcompensate for such objects (e.g., resulting in an undesirable infrared image 2650 as shown in FIG. 6B). Rather, using this approach, object 2621 may not cause any change to column correction terms (e.g., resulting in an unchanged infrared image 2600 as shown in FIG. 6A). However, larger objects such as object 2721 which may be legitimately identified as column noise may be appropriately reduced through adjustment of column correction terms (e.g., resulting in a corrected infrared image 2750 as shown in FIG. 7B).

In addition, using this approach may reduce the effects of other types of scene information on column correction term values. In this regard, counters A, B, and C identify relative relationships (e.g., less than, equal to, or greater than relationships) between pixels of the selected column and neighborhood pixels. In some embodiments, such relative relationships may correspond, for example, to the sign (e.g., positive, negative, or zero) of the difference between the values of pixels of the selected column and the values of neighborhood pixels. By using relative relationships rather than actual numerical differences, exponential scene changes (e.g., non-linear scene information gradients) may contribute less to column correction term determinations. For example, exponentially higher digital counts in certain pixels may be treated as simply being greater than or less than other pixels for comparison purposes and consequently will not unduly skew the column correction term.

In addition, by identifying relative relationships rather than actual numerical differences in counters A, B, and C, high pass filtering can be reduced in some embodiments. In this regard, where low frequency scene information or noise remains fairly uniform throughout compared neighborhoods of pixels, such low frequency content may not significantly affect the relative relationships between the compared pixels.

Advantageously, counters A, B, and C provide an efficient approach to calculating column correction terms. In this regard, in some embodiments, only three counters A, B, and C are used to store the results of all pixel comparisons performed for a selected column. This contrasts with various other approaches in which many more unique values are stored (e.g., where particular numerical differences, or the number of occurrences of such numerical differences, are stored).

In some embodiments, where the total number of rows of an infrared image is known, further efficiency may be achieved by omitting counter B. In this regard, the total number of counts may be known based on the range of columns used for comparison and the number of rows of the infrared image. In addition, it may be assumed that any comparisons that do not result in counter A or counter C being adjusted will correspond to those comparisons where pixels have equal values. Therefore, the value that would have been held by counter B may be determined from counters A and C (e.g., (number of rows×range)−counter A value−counter B value=counter C value).

In some embodiments, only a single counter may be used. In this regard, a single counter may be selectively adjusted in a first manner (e.g., incremented or decremented) for each comparison where the pixel of the selected column has a greater value than a compared pixel, selectively adjusted in a second manner (e.g., decremented or incremented) for each comparison where the pixel of the selected column has a lesser value than a compared pixel, and not adjusted (e.g., retaining its existing value) for each comparison where the pixel of the selected column has an equal (e.g., exactly equal or substantially equal) value as a compared pixel. Thus, the value of the single counter may indicate relative numbers of compared pixels that are greater than or less than the pixels of the selected column (e.g., after all pixels of the selected column have been compared with corresponding neighborhood pixels).

A column correction term for the selected column may be updated (e.g., incremented, decremented, or remain the same) based on the value of the single counter. For example, in some embodiments, if the single counter exhibits a baseline value (e.g., zero or other number) after comparisons are performed, then the column correction term may remain the same. In some embodiments, if the single counter is greater or less than the baseline value, the column correction term may be selectively incremented or decremented as appropriate to reduce the overall differences between the compared pixels and the pixels of the selected column. In some embodiments, the updating of the column correction term may be conditioned on the single counter having a value that differs from the baseline value by at least a threshold amount to prevent undue skewing of the column correction term based on limited numbers of compared pixels having different values from the pixels of the selected column.

These techniques may also be used to compensate for larger vertical anomalies in infrared images where appropriate. For example, FIG. 7A illustrates an infrared image 2700 of scene 2170 in accordance with an embodiment of the disclosure. Similar to infrared image 2600, infrared image 2700 depicts scene 2170 as relatively uniform, with a majority of pixels 2710 of infrared image 2700 having the same or similar intensity. Also in this embodiment, a column 2720A of infrared image 2700 includes pixels 2722A-M that are somewhat darker than pixels 2710, while the remaining pixels 2724 of column 2720A have a substantially uniform intensity with pixels 2710.

However, in contrast to pixels 2622A-D of FIG. 6A, pixels 2722A-M of FIG. 7A occupy a significant majority of column 2720A. As such, it is more likely that an object 2721 depicted by pixels 2722A-M may actually be an anomaly such as column noise or another undesired source rather than an actual structure or other actual scene information. For example, in some embodiments, it is contemplated that actual scene information that occupies a significant majority of at least one column would also likely occupy a significant horizontal portion of one or more rows. For example, a vertical structure in close proximity to image capture component 2130 may be expected to occupy multiple columns and/or rows of infrared image 2700. Because object 2721 appears as a tall narrow band occupying a significant majority of only one column 2720A, it is more likely that object 2721 is actually column noise.

FIG. 7B shows a corrected version 2750 of infrared image 2700 of FIG. 7A. As shown in FIG. 7B, column 2720A has been brightened, but not as significantly as column 2620A of infrared image 2650. Pixels 2722A-M have been made lighter, but still appear slightly darker than pixels 2710. In another embodiment, column 2720A may be corrected such that pixels 2722A-M may be approximately uniform with pixels 2710. As also shown in FIG. 7B, remaining pixels 2724 of column 2720A have been brightened but not as significantly as pixels 2624 of infrared image 2650. In another embodiment, pixels 2724 may be further brightened or may remain substantially uniform with pixels 2710.

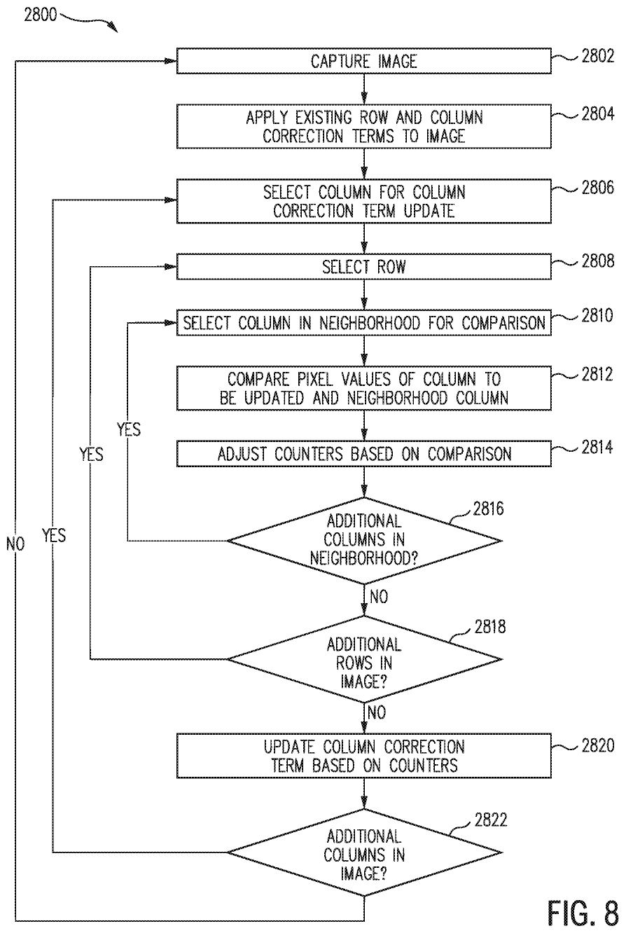

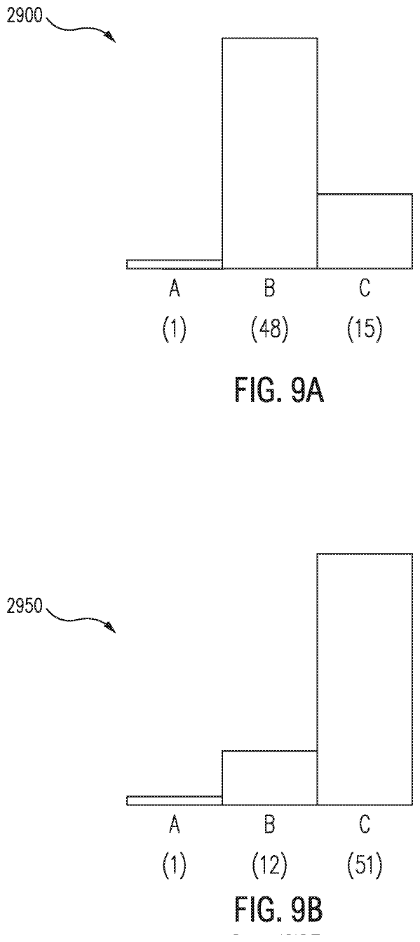

Various aspects of these techniques are further explained with regard to FIGS. 8 and 9A-B. In this regard, FIG. 8 is a flowchart illustrating a method 2800 for noise filtering an infrared image, in accordance with an embodiment of the disclosure. Although particular components of system 2100 are referenced in relation to particular blocks of FIG. 8, the various operations described with regard to FIG. 8 may be performed by any appropriate components, such as image capture component 2130, processing component, 2110, noise filtering module 2112, memory component 2120, control component 2140, and/or others.

In block 2802, image capture component 2130 captures an infrared image (e.g., infrared image 2600 or 2700) of scene 2170. In block 2804, noise filtering module 2112 applies existing row and column correction terms to infrared image 2600/2700. In some embodiments, such existing row and column correction terms may be determined by any of the various techniques described herein, factory calibration operations, and/or other appropriate techniques. In some embodiments, the column correction terms applied in block 2804 may be undetermined (e.g., zero) during a first iteration of block 2804, and may be determined and updated during one or more iterations of FIG. 8.

In block 2806, noise filtering module 2112 selects a column of infrared image 2600/2700. Although column 2620A/2720A will be referenced in the following description, any desired column may be used. For example, in some embodiments, a rightmost or leftmost column of infrared image 2600/2700 may be selected in a first iteration of block 2806. In some embodiments, block 2806 may also include resetting counters A, B, and C to zero or another appropriate default value.

In block 2808, noise filtering module 2112 selects a row of infrared image 2600/2700. For example, a topmost row 2601A/2701A of infrared image 2600/2700 may be selected in a first iteration of block 2808. Other rows may be selected in other embodiments.

In block 2810, noise filtering module 2112 selects another column in a neighborhood for comparison to column 2620A. In this example, the neighborhood has a range of two columns (e.g., columns 2620B-E/2720B-E) on both sides of column 2620A/2720A, corresponding to pixels 2602B-E/2702B-E in row 2601A/2701A on either side of pixel 2602A/2702A. Accordingly, in one embodiment, column 2620B/2720B may be selected in this iteration of block 2810.

In block 2812, noise filtering module 2112 compares pixels 2602B/2702B to pixel 2602A/2702A. In block 2814, counter A is adjusted if pixel 2602A/2702A has a lower value than pixel 2602B/2702B. Counter B is adjusted if pixel 2602A/2702A has an equal value as pixel 2602B/2702B. Counter C is adjusted if pixel 2602A/2702A has a higher value than pixel 2602B/2702B. In this example, pixel 2602A/2702A has an equal value as pixel 2602B/2702B. Accordingly, counter B will be adjusted, and counters A and C will not be adjusted in this iteration of block 2814.

In block 2816, if additional columns in the neighborhood remain to be compared (e.g., columns 2620C-E/2720C-E), then blocks 2810-2816 are repeated to compare the remaining pixels of the neighborhood (e.g., pixels 2602B-E/2702B-E residing in columns 2620C-E/2720C-E and in row 2601A/2701A) to pixel 2602A/2702A. In FIGS. 6A/7A, pixel 2602A/2702A has an equal value as all of pixels 2602B-E/2702B-E. Accordingly, after pixel 2602A/2702A has been compared with all pixels in its neighborhood, counter B will have been adjusted by four counts, and counters A and C will not have been adjusted.

In block 2818, if additional rows remain in infrared images 2600/2700 (e.g., rows 2601B-P/2701B-P), then blocks 2808-2818 are repeated to compare the remaining pixels of column 2620A/2720A with the remaining pixels of columns 2602B-E/2702B-E on a row by row basis as discussed above.

Following block 2818, each of the 16 pixels of column 2620A/2720A will have been compared to 4 pixels (e.g., pixels in columns 2620B-E residing in the same row as each compared pixel of column 2620A/2720A) for a total of 64 comparisons. This results in 64 adjustments collectively shared by counters A, B, and C.

FIG. 9A shows the values of counters A, B, and C represented by a histogram 2900 after all pixels of column 2620A have been compared to the various neighborhoods of pixels included in columns 2620B-E, in accordance with an embodiment of the disclosure. In this case, counters A, B, and C have values of 1, 48, and 15, respectively. Counter A was adjusted only once as a result of pixel 2622A of column 2620A having a lower value than pixel 2630 of column 2620B. Counter C was adjusted 15 times as a result of pixels 2622A-D each having a higher value when compared to their neighborhood pixels of columns 2620B-E (e.g., except for pixel 2630 as noted above). Counter B was adjusted 48 times as a result of the remaining pixels 2624 of column 2620A having equal values as the remaining neighborhood pixels of columns 2620B-E.

FIG. 9B shows the values of counters A, B, and C represented by a histogram 2950 after all pixels of column 2720A have been compared to the various neighborhoods of pixels included in columns 2720B-E, in accordance with an embodiment of the disclosure. In this case, counters A, B, and C have values of 1, 12, and 51, respectively. Similar to FIG. 9A, counter A in FIG. 9B was adjusted only once as a result of a pixel 2722A of column 2720A having a lower value than pixel 2730 of column 2720B. Counter C was adjusted 51 times as a result of pixels 2722A-M each having a higher value when compared to their neighborhood pixels of columns 2720B-E (e.g., except for pixel 2730 as noted above). Counter B was adjusted 12 times as a result of the remaining pixels of column 2720A having equal values as the remaining neighborhood compared pixels of columns 2720B-E.

Referring again to FIG. 8, in block 2820, the column correction term for column 2620A/2720A is updated (e.g., selectively incremented, decremented, or remain the same) based on the values of counters A, B, and C. For example, as discussed above, in some embodiments, the column correction term may be incremented if counter A−counter B−counter C>D; the column correction term may be decremented if counter C−counter A−counter B>D; and the column correction term may remain the same in all other cases.

In the case of infrared image 2600, applying the above calculations to the counter values identified in FIG. 9A results in no change to the column correction term (e.g., 1(counter A)−48(counter B)−15(counter C)=−62 which is not greater than D, where D equals (16 rows)/2; and 15(counter C)−1(counter A)−48(counter B)=−34 which is not greater than D, where D equals (16 rows)/2). Thus, in this case, the values of counters A, B, and C, and the calculations performed thereon indicate that values of pixels 2622A-D are associated with an actual object (e.g., object 2621) of scene 2170. Accordingly, the small vertical structure 2621 represented by pixels 2622A-D will not result in any overcompensation in the column correction term for column 2620A.

In the case of infrared image 2700, applying the above calculations to the counter values identified in FIG. 9B results in a decrement in the column correction term (e.g., 51(counter C)−1(counter A)−12(counter B)=38 which is greater than D, where D equals (16 rows)/2). Thus, in this case, the values of counters A, B, and C, and the calculations performed thereon indicate that the values of pixels 2722A-M are associated with column noise. Accordingly, the large vertical object 2721 represented by pixels 2722A-M will result in a lightening of column 2720A to improve the uniformity of corrected infrared image 2750 shown in FIG. 7B.

At block 2822, if additional columns remain to have their column correction terms updated, then the process returns to block 2806 wherein blocks 2806-2822 are repeated to update the column correction term of another column. After all column correction terms have been updated, the process returns to block 2802 where another infrared image is captured. In this manner, FIG. 8 may be repeated to update column correction terms for each newly captured infrared image.

In some embodiments, each newly captured infrared image may not differ substantially from recent preceding infrared images. This may be due to, for example, a substantially static scene 2170, a slowing changing scene 2170, temporal filtering of infrared images, and/or other reasons. In these cases, the accuracy of column correction terms determined by FIG. 8 may improve as they are selectively incremented, decremented, or remain unchanged in each iteration of FIG. 8. As a result, in some embodiments, many of the column correction terms may eventually reach a substantially steady state in which they remain relatively unchanged after a sufficient number of iterations of FIG. 8, and while the infrared images do not substantially change.

Other embodiments are also contemplated. For example, block 2820 may be repeated multiple times to update one or more column correction terms using the same infrared image for each update. In this regard, after one or more column correction terms are updated in block 2820, the process of FIG. 8 may return to block 2804 to apply the updated column correction terms to the same infrared image used to determine the updated column correction terms. As a result, column correction terms may be iteratively updated using the same infrared image. Such an approach may be used, for example, in offline (non-realtime) processing and/or in realtime implementations with sufficient processing capabilities.

In addition, any of the various techniques described with regard to FIGS. 6A-9B may be combined where appropriate with the other techniques described herein. For example, some or all portions of the various techniques described herein may be combined as desired to perform noise filtering.

Although column correction terms have been primarily discussed with regard to FIGS. 6A-9B, the described techniques may be applied to row-based processing. For example, such techniques may be used to determine and update row correction terms without overcompensating for small horizontal structures appearing in scene 2170, while also appropriately compensating for actual row noise. Such row-based processing may be performed in addition to, or instead of various column-based processing described herein. For example, additional implementations of counters A, B, and/or C may be provided for such row-based processing.

In some embodiments where infrared images are read out on a row-by-row basis, row-corrected infrared images may be rapidly provided as row correction terms are updated. Similarly, in some embodiments where infrared images are read out on a column-by-column basis, column-corrected infrared images may be rapidly provided as column correction terms are updated.

In some embodiments, only a single counter may be used. In this regard, a single counter may be selectively adjusted in a first manner (e.g., incremented or decremented) for each comparison where the selected pixel has a greater value than a neighborhood pixel, selectively adjusted in a second manner (e.g., decremented or incremented) for each comparison where the selected pixel has a lesser value than a neighborhood pixel, and not adjusted (e.g., retaining its existing value) for each comparison where the selected pixel has an equal (e.g., exactly equal or substantially equal) value as a neighborhood pixel. Thus, the value of the single counter may indicate relative numbers of compared pixels that are greater than or less than the selected pixel (e.g., after the selected pixel has been compared with all of its corresponding neighborhood pixels).

A NUC term for the selected pixel may be updated (e.g., incremented, decremented, or remain the same) based on the value of the single counter. For example, in some embodiments, if the single counter exhibits a baseline value (e.g., zero or other number) after comparisons are performed, then the NUC term may remain the same. In some embodiments, if the single counter is greater or less than the baseline value, the NUC term may be selectively incremented or decremented as appropriate to reduce the overall differences between the selected pixel and its corresponding neighborhood pixels. In some embodiments, the updating of the NUC term may be conditioned on the single counter having a value that differs from the baseline value by at least a threshold amount to prevent undue skewing of the NUC term based on limited numbers of neighborhood pixels having different values from the selected pixel.

Further aspects of row and column noise reduction in thermal images may be incorporated into the embodiments herein, such as described in U.S. Pat. No. 9,235,876, which is incorporated by reference into this disclosure in its entirety.

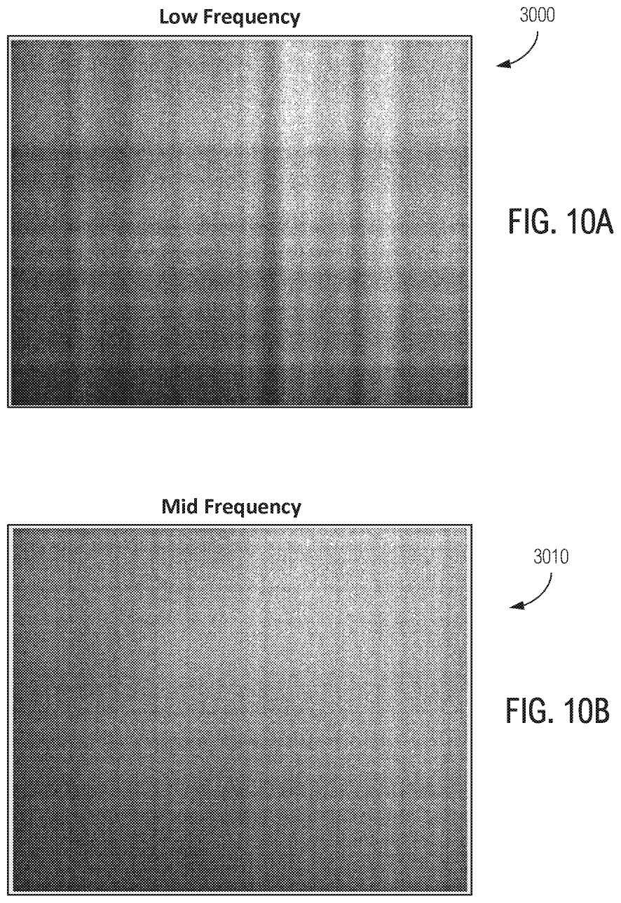

Referring to FIGS. 10A-14, additional embodiments of spatial column noise reduction (SCNR) and spatial row noise reduction (SRNR) will now be described. FIG. 10A illustrates an example image 3000 of laser beam artifacts (e.g., burn-in) in a thermal image. As illustrated in the example image 3010 of FIG. 10B, residual column noise due to, for example, temporal column noise and mid-spatial frequencies may be present after noise reduction as described with reference to FIGS. 1-9B. The embodiments described below address low frequency noise reduction and/or mid frequency noise reduction.

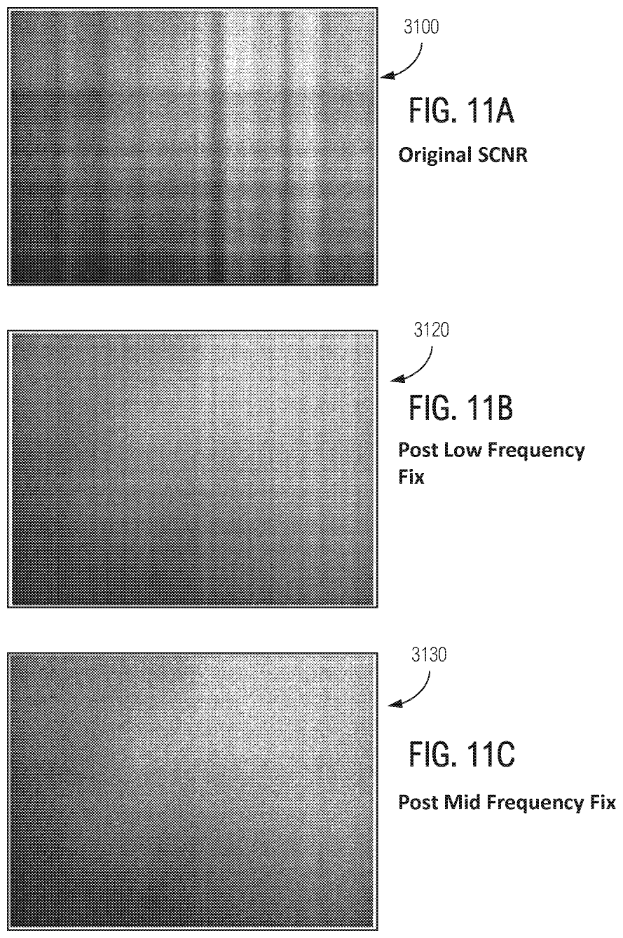

Referring to FIG. 11A, an example image 3100 is generated after noise reduction from an SCNR process (e.g., as described with reference to FIGS. 1-9B). FIG. 11B illustrates an example image 3110, which is the image 3100 after low frequency noise reduction as described herein. In some embodiments, low frequency noise reduction includes applying a high pass filter to the SCNR corrected image every few frames to retain high frequency column correction. FIG. 11C illustrates an example image 3120, which is the image 3110 after mid frequency noise reduction as described herein. In some embodiments, this residual column noise reduction may include running SCNR every frame (e.g., rather than every 4 frames), down sampling the columns (e.g., by 4) and performing SCNR logic on the down sampled image. The corrected image is then up sampled and may be combined with the SCNR correction.

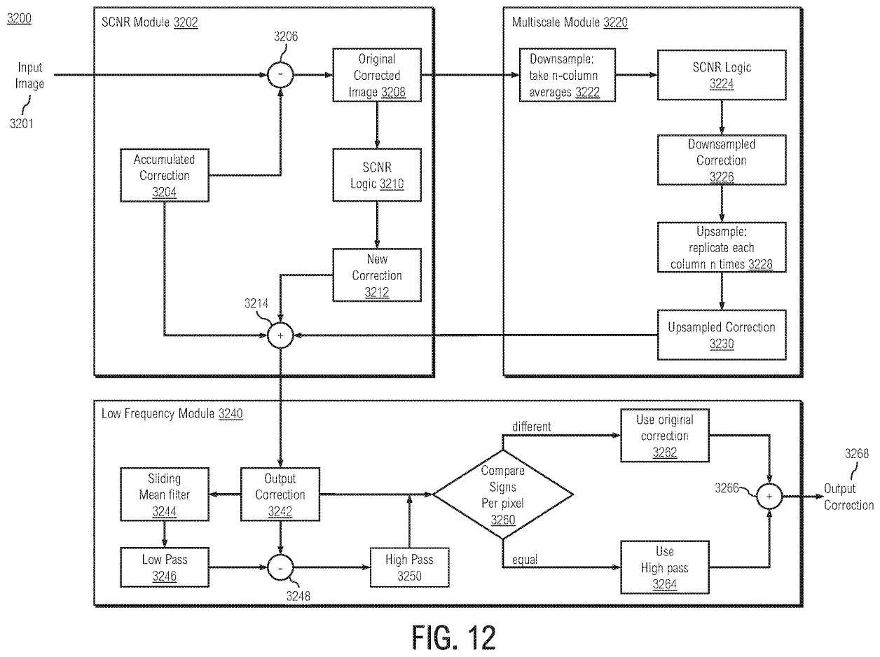

FIG. 12 illustrates an example process 3200 for spatial column noise reduction and spatial row noise reduction that addresses multiscale and/or low frequency noise reduction, in accordance with one or more embodiments. An input image 3201 is first processed by an SCNR module 3201, which may include, for example, logic as previously described in FIGS. 1-9B. As illustrated, the SCNR module 3202 maintains an accumulated correction 3204 which is subtracted from the input image at block 3206 to generate an original corrected image 3208. At block 3210, SCNR logic is applied to the original corrected image 3208 to generate a new correction 3212.

The SCNR module 3202 is configured to address high frequency column noise, but there may be some wider column bands that the single-column corrections of the SCNR module 3202 may not correct well. To capture these mid frequency, a multiscale module 3220 is used to run SCNR on a multiscale basis. The original corrected image 3208 is also provided to a multiscale module 3220 which is configured to provide additional mid frequency noise reduction. As illustrated, the original corrected image 3208 is down sampled at block 3222. In some embodiments, the down sampling includes taking n-column averages where n is an integer greater than one (e.g., n=4 columns). At block 3224, the SCNR logic is applied to the down sampled image to generate a down sampled correction 3226. The down sampled correction 3226 is then up sampled. In some embodiments, the up sampling includes replicating each column n times to generate an up sampled correction 3230.

In some implementations, the multiscale module 3220 takes 4-column pixel averages to generate the down sampled image (e.g., having a resolution of rows×cols/4). The SCNR algorithm is performed on this smaller image. In some embodiments, the SCNR algorithm may be implemented using the SCNR module 3202, the SCNR algorithm may be implemented in the multiscale module 3220, or through another module. In various embodiments, the same SCNR algorithm is used for both the SCNR module 3202 and the multiscale module 3220. The correction is then up sampled by 4 by replication, repeating each value 4 times.

Referring back to the SCNR module 3202, block 3214 combines the up sampled correction 3230, accumulated correction 3204, and new correction 3212, to generate an output correction 3242. In some implementations, the SCNR algorithm is separately performed on the original sized image and the down sampled image and the corrections are combined to generate the total column correction. The two sets of calculations can be performed either inline or sequentially, but are here done separately for clarity.

In some embodiments, the low frequency module 3240 receives the output correction 3242 and processes every mth image frame, where m is an integer greater than 1 (e.g., every m=10 frames). The output correction 3242 is provided to block 3244 which is configured to apply a sliding mean filter 3244 to the output correction 3242. For example, a sliding mean filter with a kernel size 1×17 (or other values as appropriate) across the input correction and round the results to get a blurred lowpass correction. The result is then fed through a low pass filter 3246 and subtracted from the output correction 3242. This result is then fed through a high pass filter 3250 which is provided, along with the original output correction image 3242 to block 3260.

In block 3260, the signs of each pixel from the output correction block 3242 and the high pass filter block 3250 are compared. If the signs are different, then the original correction is used in block 3262. If the signs are equal, then the lowpass value is subtracted from the input value (e.g., at block 3266) to get a new value (output correction=input correction−lowpass correction). The resulting pixel value is used to generate the output correction 3268.

As previously discussed, the SCNR approach described herein (e.g., with reference to FIGS. 1-9B) may be prone to generating an artefact wherein a small hot object causes a wide band of overcorrection that the algorithm cannot recover from even when the object is removed. This can be prevented by applying a high pass filter (e.g., high pass filter 3250) to the correction every 10 iterations (or other frequency as desired) of SCNR and removing low frequency banding (e.g., low pass filter 3246) from the corrections, as column noise typically the only high frequency. In test environments, applying the low frequency fix every 10 frames provides desirable results. If the low frequency fix is applied too frequently, it may include more high frequency content. If the low frequency fix is applied too rarely, it may be less effective at preventing the artefacts.

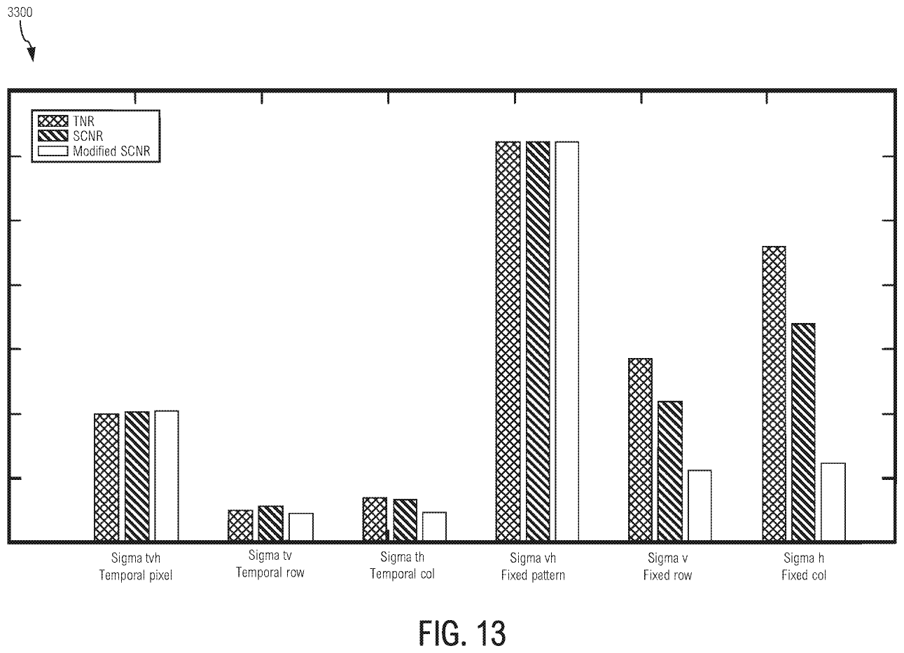

Referring to FIG. 13, example test results comparing temporal noise reduction, spatial column noise reduction (e.g., as described with reference to FIGS. 1-9B), and modified SCNR including low frequency and mid frequency adjustments (e.g., as described with reference to FIGS. 10-12). As illustrated, the SCNR approach yields better overall results compared to temporal noise reduction approaches, and the modified SCNR generates better overall results compared to the SCNR approach of FIGS. 1-9B by reducing row and column noise after applying the low frequency and multiscale noise reduction processing. The original SCNR approach generates a correction map that includes low frequency artefacts and corrected high noise frequencies. The modified SCNR mitigates the low frequency artefacts and corrects both mid and high noise frequencies.

FIGS. 10-12 illustrate two modifications to the SCNR algorithm of FIGS. 1-9B that improve noise reduction performance. The modified SCNR approach may be implemented as separate modules for SCNR, multiscale noise reduction, and low frequency artefact reduction. The modules may operate independently and in some embodiments, the modules can be implemented to not interact with each other. In some embodiments, the system may be configured to perform SCNR noise reduction, SCNR noise reduction with multiscale noise reduction, SCNR noise reduction with low frequency artefact noise reduction, and/or SCNR with both multiscale noise reduction and low frequency artefact noise reduction. In some embodiments, one or more of the module may be combined with other noise reduction techniques. In some embodiments, the multiscale noise reduction and/or low frequency artefact noise reduction techniques described herein may be implemented with SRNR.

As described herein, in some embodiments, a method includes receiving an image frame comprising a plurality of pixels arranged in a plurality of rows and columns, wherein the pixels comprise infrared image data associated with a scene and noise introduced by an infrared imaging device, processing the image frame using a first process to determine a plurality of column correction terms to reduce at least a portion of the noise, wherein each column correction term is associated with a corresponding one of the columns and is determined based on relative relationships between the pixels of the corresponding column and the pixels of a neighborhood of columns, and modifying the column correction terms to reduce residual noise and/or artefacts in the processed image frame.

The first process may include determining the plurality of column correction terms to reduce high frequency noise, wherein modifying the column correction terms comprises determining a plurality of column correction terms to reduce at least a portion of the noise at a frequency lower than the high frequency noise. Modifying the column correction terms may further include down sampling the image frame to reduce the plurality of columns, and processing the down sampled image frame using the first process to determine a plurality of down sampled column correction terms to reduce at least a portion of the noise. Modifying the column correction terms may further include up sampling the down sampled column correction terms to generate up sampled correction terms, and modifying the column correction terms based at least in part on the up sampled correction terms. The down sampling may include computing an average value of n columns, where up sampling includes replicating each down sampled column n times, where n is an integer greater than or equal to two.

Modifying the column correction terms may further include applying a sliding mean filter and low pass filter to the column correction terms to generate a second set of column correction terms, applying a high pass filter to a difference between the column correction terms and the second set of column correction terms to generate high pass column correction terms, and generating modified correction terms based at least in part on a comparison between the column correction terms and the high pass column correction terms.

Any of the various methods, processes, and/or operations described herein may be performed by any of the various systems, devices, and/or components described herein where appropriate. For example, in some embodiments a system may include a memory component adapted to receive an image frame comprising a plurality of pixels arranged in a plurality of rows and columns, wherein the pixels comprise infrared image data associated with a scene and noise introduced by an infrared imaging device, and a processor configured to execute instructions to (i) process the image frame using a first process to determine a plurality of column correction terms to reduce at least a portion of the noise, wherein each column correction term is associated with a corresponding one of the columns and is determined based on relative relationships between the pixels of the corresponding column and the pixels of a neighborhood of columns, and (ii) modify the column correction terms to reduce residual noise and/or artefacts in the processed image frame.

Where applicable, various embodiments provided by the present disclosure can be implemented using hardware, software, or combinations of hardware and software. Also, where applicable, the various hardware components and/or software components set forth herein can be combined into composite components comprising software, hardware, and/or both without departing from the spirit of the present disclosure. Where applicable, the various hardware components and/or software components set forth herein can be separated into sub-components comprising software, hardware, or both without departing from the spirit of the present disclosure. In addition, where applicable, it is contemplated that software components can be implemented as hardware components, and vice-versa.

Software in accordance with the present disclosure, such as non-transitory instructions, program code, and/or data, can be stored on one or more non-transitory machine-readable mediums. It is also contemplated that software identified herein can be implemented using one or more general purpose or specific purpose computers and/or computer systems, networked and/or otherwise. Where applicable, the ordering of various steps described herein can be changed, combined into composite steps, and/or separated into sub-steps to provide features described herein.

Embodiments described above illustrate but do not limit the present disclosure. It should also be understood that numerous modifications and variations are possible in accordance with the principles of the present disclosure. Accordingly, the scope of the invention is defined only by the following claims.

What is claimed is:

1. A method comprising:
receiving an image frame comprising a plurality of pixels arranged in a plurality of rows and columns, wherein the pixels comprise infrared image data associated with a scene and noise introduced by an infrared imaging device;
processing the image frame using a first process to determine a plurality of column correction terms to reduce at least a portion of the noise, wherein each column correction term is associated with a corresponding one of the columns and is determined based on relative relationships between the pixels of the corresponding column and the pixels of a neighborhood of columns; and
modifying the column correction terms to reduce residual noise and/or artefacts in the processed image frame.

2. The method of claim 1, wherein the first process comprises determining the plurality of column correction terms to reduce high frequency noise; and
wherein modifying the column correction terms comprises determining a plurality of column correction terms to reduce at least a portion of the noise at a frequency lower than the high frequency noise.

3. The method of claim 2, wherein modifying the column correction terms further comprises down sampling the image frame to reduce the plurality of columns; and
processing the down sampled image frame using the first process to determine a plurality of down sampled column correction terms to reduce at least a portion of the noise.

4. The method of claim 3, wherein modifying the column correction terms further comprises up sampling the down sampled column correction terms to generate up sampled correction terms; and
modifying the column correction terms based at least in part on the up sampled correction terms.

5. The method of claim 4, wherein down sampling comprises computing an average value of n columns;
wherein up sampling comprises replicating each down sampled column n times; and
wherein n is an integer greater than or equal to two.

6. The method of claim 1, wherein modifying the column correction terms comprises:
applying a sliding mean filter and low pass filter to the column correction terms to generate a second set of column correction terms;
applying a high pass filter to a difference between the column correction terms and the second set of column correction terms to generate high pass column correction terms; and
generating modified correction terms based at least in part on a comparison between the column correction terms and the high pass column correction terms.

7. The method of claim 6, wherein generating modified correction terms comprises, on a pixel-by-pixel basis:
using the column correction terms if the column correction terms and high pass column correction terms have a same sign; and
using the high pass column correction terms if the column correction terms and high pass column correction terms have different signs.

8. The method of claim 7, wherein generating modified correction terms is performed every mth image frame, where m is an integer greater than or equal to 10.

9. The method of claim 1, wherein the processing the image frame comprises:
selecting one of the columns;
for each pixel of the selected column, comparing the pixel to a corresponding plurality of neighborhood pixels in the neighborhood of columns;
for each comparison, adjusting a first counter if the pixel of the selected column has a value greater than the compared neighborhood pixel;
for each comparison, adjusting a second counter if the pixel of the selected column has a value less than the compared neighborhood pixel; and
selectively updating the column correction term associated with the selected column based on the first and second counters; and
wherein the neighborhood pixels corresponding to each pixel of the selected column reside in a neighborhood defined by an intersection of the same row as the pixel of the selected column and a predetermined range of columns.

10. The method of claim 1, further comprising:
processing the image frame using a second process to determine a plurality of row correction terms to reduce at least a portion of the noise, wherein each row correction term is associated with a corresponding one of the row and is determined based on relative relationships between the pixels of the corresponding row and the pixels of a neighborhood of rows; and
modifying the row correction terms to reduce residual noise and/or artefacts in the processed image frame.

11. A system comprising:
a memory component adapted to receive an image frame comprising a plurality of pixels arranged in a plurality of rows and columns, wherein the pixels comprise infrared image data associated with a scene and noise introduced by an infrared imaging device; and
a processor configured to execute instructions to:
process the image frame using a first process to determine a plurality of column correction terms to reduce at least a portion of the noise, wherein each column correction term is associated with a corresponding one of the columns and is determined based on relative relationships between the pixels of the corresponding column and the pixels of a neighborhood of columns; and
modify the column correction terms to reduce residual noise and/or artefacts in the processed image frame.

12. The system of claim 11, wherein the first process comprises determining the plurality of column correction terms to reduce high frequency noise; and
wherein modifying the column correction terms comprises determining a plurality of column correction terms to reduce at least a portion of the noise at a frequency lower than the high frequency noise.

13. The system of claim 12, wherein modifying the column correction terms further comprises down sampling the image frame to reduce the plurality of columns; and
processing the down sampled image frame using the first process to determine a plurality of down sampled column correction terms to reduce at least a portion of the noise.

14. The system of claim 13, wherein modifying the column correction terms further comprises up sampling the down sampled column correction terms to generate up sampled correction terms; and
modifying the column correction terms based at least in part on the up sampled correction terms.

15. The system of claim 14, wherein down sampling comprises computing an average value of n columns;
wherein up sampling comprises replicating each down sampled column n times; and
wherein n is an integer greater than or equal to two.

16. The system of claim 11, wherein modifying the column correction terms comprises:
applying a sliding mean filter and low pass filter to the column correction terms to generate a second set of column correction terms;
applying a high pass filter to a difference between the column correction terms and the second set of column correction terms to generate high pass column correction terms; and
generating modified correction terms based at least in part on a comparison between the column correction terms and the high pass column correction terms.

17. The system of claim 16, wherein generating modified correction terms comprises, on a pixel-by-pixel basis:
using the column correction terms if the column correction terms and high pass column correction terms have a same sign; and
using the high pass column correction terms if the column correction terms and high pass column correction terms have different signs.

18. The system of claim 17, wherein generating modified correction terms is performed every mth image frame, where m is an integer greater than or equal to 10.

19. The system of claim 11, wherein the processing the image frame comprises:
selecting one of the columns;
for each pixel of the selected column, comparing the pixel to a corresponding plurality of neighborhood pixels in the neighborhood of columns;
for each comparison, adjusting a first counter if the pixel of the selected column has a value greater than the compared neighborhood pixel;
for each comparison, adjusting a second counter if the pixel of the selected column has a value less than the compared neighborhood pixel; and
selectively updating the column correction term associated with the selected column based on the first and second counters.

20. The system of claim 19, wherein the neighborhood pixels corresponding to each pixel of the selected column reside in a neighborhood defined by an intersection of: the same row as the pixel of the selected column; and a predetermined range of columns.
